(19) United States
(12) Patent Application Publication
(10) Pub. No.: US 2026/0285526 A1
(43) Pub. Date: Sep. 24, 2026

(54) SEALING TOOL, PACKAGING MACHINE AND METHOD FOR MANUFACTURING A SEALED BAG

(71) Applicant: OPTIMA life science GmbH, Schwäbisch Hall (DE)

(72) Inventor: Alexander Müller, Schwäbisch Hall (DE)

(73) Assignee: OPTIMA life science GmbH, Schwäbisch Hall (DE)

(21) Appl. No.: 19/569,872

(22) Filed: Mar. 17, 2026

(30) Foreign Application Priority Data
Mar. 18, 2025 (DE) 102025110314.3

(51) Int. Cl. B65B 51/14; B65B 51/32

(52) U.S. Cl. CPC B65B 51/146; B65B 51/32

(57) ABSTRACT

The invention relates to a sealing tool, in particular, for producing a seal pouch packaging for a product, wherein the sealing tool comprises a sealing punch, a pressing element, a cooling device for cooling the pressing element, and a pressure cushion, wherein the sealing punch has a sealing-seam contour at one end, wherein the sealing punch is advanceable in a pressing direction toward an element to be sealed, wherein the pressing element, together with the sealing punch, is advanceable toward the element to be sealed and movable away from the element to be sealed, wherein the pressing element is mounted so as to be moveable relative to the sealing punch in the pressing direction, and wherein a force acts on the pressing element such that the pressing element carries out a stroke movement, in such a way that the pressing element, when advancing the sealing punch, contacts the element to be sealed before the sealing-seam contour and/or, when moving the sealing punch away from the element to be sealed, lifts off the element to be sealed after the sealing-seam contour. The invention further relates to a packaging machine and method for producing seal pouch packaging.

### CROSS-REFERENCE TO RELATED APPLICATION

The present application claims priority to German Patent Application No. 102025110314.3, filed Mar. 18, 2025, the entirety of which is incorporated herein by reference.

### FIELD OF APPLICATION AND PRIOR ART

The invention relates to a sealing tool, in particular, for producing seal pouch packaging. The invention further relates to a packaging machine and method for producing seal pouch packaging.

“Sealing” is herein defined as a joining of layers of a packaging material along a sealing seam, in particular, under the action of elevated temperatures and/or under pressure. In application cases, the layers are films of a monomaterial, for example, polypropylene or polyethylene. In application cases, one or both of the layers are a multilayer film, in particular, a film comprising a carrier material and at least one coating, in particular, a thermoplastic coating, which is melted to join the films. The carrier material is, for example, a fiber-based carrier material and/or aluminum and, in embodiments, is not melted when joining the layers. In embodiments, one of the layers comprises no coating that is melted during sealing. Layers without coating, layers made of monomaterial, as well as multilayer layers are herein uniformly referred to as layers of packaging material or packaging-material layers. A tool for sealing two packaging-material layers is referred to as a sealing tool.

Seal pouch packaging is defined as packaging in which a product is enclosed between two packaging-material layers joined to one another along a sealing seam. The sealing seam is, in particular, closed circumferentially in order to enclose the product fluid-tight in the seal pouch.

### OBJECT AND SOLUTION

Objects of the invention are to provide an improved sealing tool, in particular, for producing a seal pouch packaging, as well as a packaging machine comprising a sealing tool. A further object of the invention is to provide an improved method for producing seal pouch packaging.

These objects are achieved by the subject matters having the features of claims 1, 10, and 11. Advantageous embodiments result from the dependent claims and the following description.

According to a first aspect, a sealing tool is provided, in particular, for producing a seal pouch packaging for a product.

The sealing tool comprises a sealing punch that has a sealing-seam contour at one end and is advanceable in a pressing direction toward an element to be sealed. After sealing has been performed, the sealing punch is liftable again opposite the pressing direction.

The sealing tool comprises a pressing element, wherein the pressing element, together with the sealing punch, is advanceable toward the element to be sealed and movable away from the element to be sealed. The pressing element is mounted so as to be moveable relative to the sealing punch in the pressing direction. The sealing tool is configured such that a force acts on the pressing element, such that the pressing element performs a stroke movement, in such a way that the pressing element, when advancing the sealing punch, contacts the element to be sealed before the sealing-seam contour and/or, when moving the sealing punch away from the element to be sealed, lifts off the element to be sealed after the sealing-seam contour.

The terms “a,” “an,” “one,” and the like are used in connection with the application merely as indefinite articles and not as numerals.

In embodiments, multiple pressing elements are provided that are mounted so as to be moveable relative to the sealing punch.

In particular, the element to be sealed is a seal pouch packaging having two packaging-material layers, which are to be joined to one another along a sealing seam. In embodiments, the packaging-material layers of the seal pouch packaging are joined along exactly one sealing seam. In embodiments, the packaging-material layers of the seal pouch packaging are joined along multiple sealing seams. In embodiments, the two packaging-material layers may be joined to one another in a tubular manner, and a seal pouch may be produced by joining at two sealing seams.

The element to be sealed comprises at least one sealing layer, which is activatable by the sealing punch in the sealing process. In particular, the element to be sealed comprises a sealing layer for heat sealing, which is activatable by heating the sealing punch. In embodiments, the sealing tool comprises a heating device, wherein at least the sealing-seam contour of the sealing punch is heatable by the heating device for activating the sealing layer.

The sealing layer of a seal pouch packaging is, depending on the application case, the same as the packaging-material layer or a coating on at least one packaging-material layer.

In embodiments, by a time-offset lifting of the pressing element relative to the sealing punch, it is achieved that a sealing layer softened for sealing by temperature and/or pressure is already solidified when lifting the pressing element. This prevents the seal from coming loose at a point where the sealing layer is not yet or not yet completely set when the sealing punch is lifted.

In embodiments, the product is a product referred to as a three-dimensional product, which has a height extending between the packaging-material layers. Three-dimensional products are products that have, transversely, in particular, perpendicularly to a plane of the sealing seam, a height that causes bulging and/or stretching of at least one packaging-material layer, such that the packaging-material layer is deflected at the sealing seam by an angle, in particular, by an angle greater than 5°, further, in particular, by an angle greater than 15°.

In embodiments, the three-dimensional product is a medical product, such as, for example, a multilayer wound dressing. However, the invention is not limited to use for medical products.

The height of the three-dimensional product causes, when introducing the product and sealing the packaging-material layers, at least one packaging-material layer at the sealing seam to be placed under tension by the product. By the pressing element, relief of the sealing seam before, during, or after sealing by the sealing punch is achieved.

The pressing element is configured as a pressing frame and has a pressing contour, wherein the pressing contour extends, at least in sections, along the sealing-seam contour, in particular, substantially parallel thereto. The pressing contour extends inside the sealing-seam contour. By the inwardly arranged pressing contour, it is, in particular, avoidable that tensile forces act on the sealing seam when lifting the sealing punch due to bulging and/or deformation of the packaging-material layer by an enclosed product.

In embodiments, the pressing element is thermally insulated relative to the sealing punch in order to avoid heating of the pressing element.

A cooling device for cooling the pressing element is provided. The cooling device is, depending on the application case, configurable such that, in particular, heating of the pressing element, in particular, at least in a region contacting the element to be sealed, to a melting temperature of the element to be sealed is avoided. As a result, in particular, in the case of heat sealing it is prevented that a sealing layer is activated by the pressing element.

In embodiments, the cooling device is configured as liquid cooling comprising cooling channels provided on the pressing element. In embodiments, the cooling device comprises Peltier elements. In embodiments, the Peltier elements are mounted on passive heat sinks, wherein the heat sinks have cooling fins that are arranged outside the sealing punch. As a result, it is prevented that the cooling fins are heated by the sealing punch.

In embodiments, the pressing element is moved, due to gravity, relative to the sealing punch into a position in which a free end of the pressing element projects in the pressing direction from the sealing-seam contour toward the element to be sealed. As a result, it is achieved that the pressing element, when advancing the sealing punch, contacts the element to be sealed before the sealing-seam contour and/or, when moving the sealing punch away from the element to be sealed, lifts off the element to be sealed after the sealing-seam contour. In embodiments, a force device is provided by which, alternatively or additionally to gravity, a force is applicable to the pressing element, in particular, in order to force the pressing element into a position in which a free end of the pressing element projects in the pressing direction from the sealing-seam contour toward the element to be sealed. The force device is, in embodiments, configured as a passive force device, in particular, as a spring element, in particular, multiple spring elements. Passive means, in this context, that the force device has no dedicated actuators. In embodiments, the spring element or the spring elements are arranged, in such a way, between the sealing punch and the pressing element that, by the spring element or the spring elements, the pressing element is forced into a position in which a free end of the pressing element projects from the sealing punch toward the element to be sealed. In embodiments, the pressing element is mounted on the sealing punch, wherein, by the stroke movement of the sealing punch, the pressing element is also moved in stroke, and the free end of the pressing element projecting from the sealing-seam contour contacts the element to be sealed before the sealing-seam contour. The stroke movement of the sealing punch is continued such that the sealing-seam contour comes into contact with the element to be sealed for sealing. With continued stroke movement of the sealing punch after the pressing element has contacted, the spring element or the spring elements are tensioned and cause a compressive force and pressing of the pressing contour onto the element to be sealed. After an application-case-dependent time, the sealing punch is raised away from the element to be sealed, wherein the tensioned spring element or the tensioned spring elements force the pressing element further toward the element to be sealed. After reaching a maximum adjustment travel between the sealing punch and the pressing element, the pressing element mounted on the sealing punch is moved away from the element together with the sealing punch.

In embodiments, the force device is configured as an active force device, in particular, is configured as a hydraulic, pneumatic, electromagnetic, or linearly acting electric drive in order to force the pressing element against the element to be sealed. Active means, in this context, that the force device has at least one dedicated actuator.

A pressure cushion is arranged inside the sealing-seam contour. In embodiments, the pressure cushion is a flexible and/or compressible insert that interacts, in particular, with the seal pouch packaging in order to remove a present gas, in particular, air, from the seal pouch packaging and/or a compressible product arranged between packaging layers of the seal pouch packaging. In particular, when advancing the sealing punch and/or the pressing element, the pressure cushion interacts with the seal pouch packaging to compress the product and, in particular, to remove a present gas, in particular, air, from the product and/or between the packaging-material layers, in particular before the sealing-seam contour contacts a first packaging-material layer. As a result, in embodiments, a size of the packaged product and/or forces acting on the sealing seam are reducible. A reduced quantity of air in the seal pouch packaging is, in applications, additionally advantageous, since less oxygen and moisture remain in the closed seal pouch packaging.

In embodiments, the pressing contour is interrupted in order to permit gas to escape from a region inside the pressing contour after the pressing contour contacts the element to be sealed. The pressing element is configured as a pressing frame having a pressing contour arranged inside the sealing-seam contour, wherein the pressure cushion is arranged in the pressing frame. By arrangement in the pressing frame, heating of the pressure cushion by the sealing punch can be prevented.

In embodiments, the pressing element is mounted on the sealing punch so as to be moveable in the pressing direction. The pressing element is thereby movable together with the sealing punch in the pressing direction, in particular, by an actuating device acting on the sealing punch. The pressing element is further moveable relative to the sealing punch by the force device in order to achieve time-offset contacting and/or lifting of the pressing element and the sealing punch.

In embodiments, the sealing tool comprises a carrier, wherein the pressing element is mounted on the carrier. In contrast to the aforementioned embodiment variant, there is no direct mechanical coupling between the sealing tool and the pressing element. In embodiments, the carrier is stroke-moved and, in particular, fixed relative to the sealing tool. In other embodiments, the carrier is fixed, wherein the sealing tool and the pressing element are each mounted on the carrier so as to be moveable in the pressing direction. In the configuration having a carrier, a force to be applied to the pressing element, in particular, a force to be applied by a force device, need not be co-borne by the sealing punch. Force measurement at the sealing punch is thus not distorted by forces acting on the pressing element.

In embodiments, the sealing tool further comprises a counter element cooperating with the sealing punch, in particular, an anvil plate or a second sealing punch. In embodiments, a pressing element is likewise arranged on the second sealing punch.

According to a second aspect, a packaging machine for producing a seal pouch packaging for a product, in particular, a three-dimensional product, is provided. The seal pouch packaging comprises a first packaging-material layer and a second packaging-material layer. The product is, in particular, a three-dimensional product.

The packaging machine is configured to introduce the product between the two packaging-material layers. The packaging machine comprises a sealing tool having a sealing punch and a pressing element in order to seal the packaging-material layers to one another along a sealing seam.

The packaging machine is configured, in particular, for web-based processing, wherein packaging-material layers provided in a web-like manner, having products arranged therebetween, are supplied to the sealing tool. The products are arranged between the packaging-material layers, in particular, at regular intervals for a uniformly clocked operation.

According to a third aspect, a method for producing a seal pouch packaging comprising a first packaging-material layer and a second packaging-material layer for a product is described. The product is introduced between the two packaging-material layers, and the packaging-material layers are sealed to one another along a sealing seam. For sealing, a sealing punch is advanced toward the packaging-material layers in a pressing direction such that a sealing-seam contour of the sealing punch contacts the first packaging-material layer facing the sealing punch.

A pressing element is advanced toward the packaging-material layers together with the sealing punch and contacts the first packaging-material layer facing the sealing punch.

The pressing element is moved at least partially with a time offset relative to the sealing punch such that, when advancing the sealing punch, the pressing element contacts the first packaging-material layer before the sealing-seam contour and/or, when moving the sealing punch away from the packaging-material layers, the pressing element lifts off the first packaging-material layer after the sealing-seam contour.

The terms “first,” “second,” and the like serve, in connection with the application, merely for distinction and do not indicate an order.

Joining of the packaging-material layers takes place, in particular, by heat sealing. The sealing punch is heated for melting one or both packaging-material layers and/or a coating on at least one packaging-material layer. A time offset upon lifting is, in particular, selected such that lifting of the pressing element occurs only after solidification of the melted packaging-material layer or layers and/or of the melted coating.

The pressing element is cooled in order to avoid melting of a sealing layer by the pressing element. Cooling of the pressing element takes place, depending on the application case, to a suitable temperature in order to avoid melting of the sealing layer, in particular, by contact with the pressing element.

In embodiments, it is provided that the pressing element, when lifting off the sealing-seam contour, is forced against the first packaging-material layer for a pressing duration and/or until reaching a maximum adjustment travel between the sealing punch and the pressing element. Forcing the pressing element against the packaging-material layer takes place, in particular, by an active and/or passive force device. A force by which the pressing element is forced against the first packaging-material layer is selectable, depending on the application case. In embodiments, for example, the pressing element is mounted on the sealing punch so as to be moveable in the pressing direction, wherein, when moving the sealing punch away from the first packaging-material layer after reaching the maximum adjustment travel between the sealing punch and the pressing element, the pressing element is moved together with the sealing punch and lifted off the packaging-material layer. In embodiments, the pressing element and the sealing punch are not directly coupled to one another, wherein, for example, when the sealing punch is moved away from the packaging-material layer, the pressing element is forced against the packaging-material layer for a pressing duration that is selectable depending on the application case.

The product is compressed, in sealing and/or prior to sealing the packaging-material layers along the sealing seam, by a pressure cushion arranged within the sealing-seam contour. In embodiments, compression begins before the sealing-seam contour contacts the first packaging-material layer. The pressure cushion is, in particular, a flexible and/or compressible insert by which a gas, in particular, air, is pressed out of the seal pouch packaging. By compressing the product, tensions in the region of the sealing seam during joining may be reduced. The pressure cushion is, in particular, arranged within a pressing contour on the pressing element, such that the pressure cushion does not heat up to the temperature of the sealing punch. As a result, melting of a sealing layer in the region of the pressure cushion is avoided.

The invention described above and below, and the described advantageous further developments of the invention, also constitute, in combination with one another, insofar as technically meaningful, advantageous further developments of the invention. With respect to further advantages and, in structural and functional terms, advantageous embodiments of the invention, reference is made to the dependent claims as well as the description of exemplary embodiments with reference to the attached figures.

### BRIEF DESCRIPTION OF THE DRAWINGS

Exemplary embodiments of the invention are explained below with reference to the figures. The same reference signs are used for identical or similar components in the figures. It shows:

FIG. 1 a sectional side view of an exemplary embodiment of a sealing tool for producing a seal pouch packaging,

FIG. 2 a partially sectional plan view of the sealing tool 1 according to FIG. 1;

FIG. 3 a sectional side view of an exemplary embodiment of a sealing tool for producing a seal pouch packaging similar to FIG. 1;

FIG. 4 a partially sectional plan view of the sealing tool 1 according to FIG. 3, and

FIG. 5 a sectional side view of an exemplary embodiment of a sealing tool for producing a seal pouch packaging similar to FIG. 1.

### DETAILED DESCRIPTION OF THE EXEMPLARY EMBODIMENTS

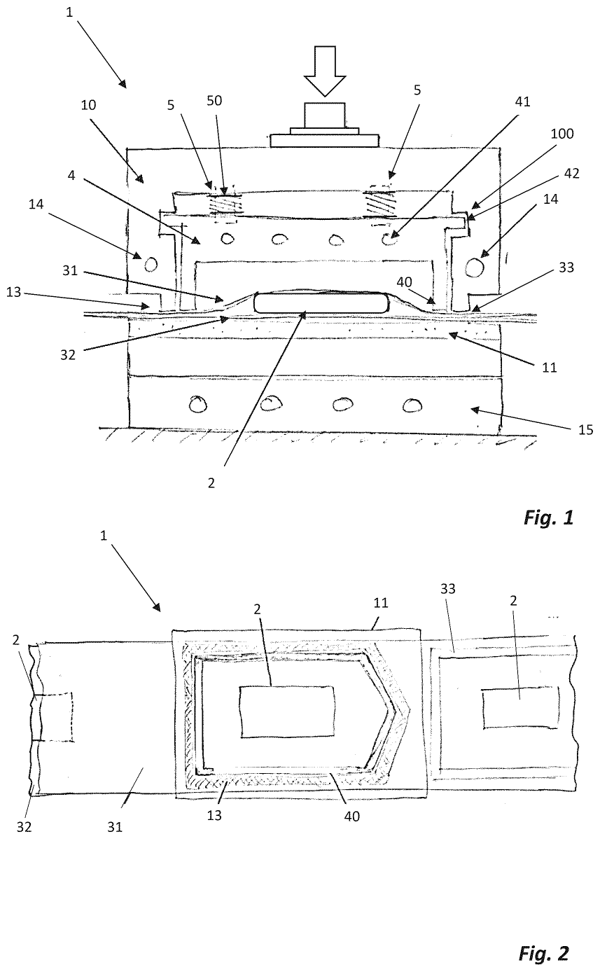

FIGS. 1 and 2 show, in a sectional side view and a partially sectional plan view, an exemplary embodiment of a sealing tool 1 for producing a seal pouch packaging for a product 2.

For producing the seal pouch packaging for the product 2, two packaging-material layers 31, 32 are sealed to one another along a sealing seam 33, and the product 2 is enclosed inside the sealing seam 33 between the two packaging-material layers 31, 32.

Sealing of the packaging-material layers 31, 32 takes place by a sealing tool 1 comprising a sealing punch 10. The packaging-material layers 31, 32 are loadable by the sealing punch 10 along a sealing seam 33 with pressure and/or temperature such that the packaging-material layers 31, 32 and/or a coating present on at least one packaging-material layer 31, 32 melts along the sealing seam 33 and, upon subsequent solidification, the packaging-material layers 31, 32 are joined to one another along the sealing seam 33.

The illustrated sealing tool 1 comprises the sealing punch 10 and an anvil plate 11. The sealing punch 10 is mounted so as to be moveable in a pressing direction illustrated by an arrow and is advanced toward the anvil plate 11 for sealing the packaging-material layers 31, 32. The sealing punch 10 comprises, on a side facing the anvil plate 11, a sealing-seam contour 13. The sealing-seam contour 13 is, in particular, closed circumferentially. The illustrated sealing punch 10 comprises heating elements 14 by which the sealing punch 10 may be heated, at least in the region of the sealing-seam contour 13. On a side of the anvil plate 11 facing away from the sealing punch 10, in the illustrated exemplary embodiment, a cooling device 15 for dissipating the heat applied by the sealing punch 10 to the anvil plate 11 is provided.

The sealing tool 1 further comprises a pressing element 4. The illustrated pressing element 4 is configured as a pressing frame and comprises a pressing contour 40. The pressing contour 40 extends, at least in sections, along the sealing-seam contour 13. In embodiments, the pressing contour 40 is arranged, as illustrated in FIGS. 1 and 2, on an inner side of the sealing-seam contour 13. In other embodiments, the pressing contour 40 is arranged on an outer side of the sealing-seam contour 13. In embodiments, the pressing contour 40 is circumferential. In other embodiments, the pressing contour 40 is interrupted along the circumference.

The pressing element 4 is, in particular, cooled. In the illustrated exemplary embodiment, the pressing element 4 comprises cooling channels 41 through which a cooling liquid may be guided. In embodiments, cooling is alternatively or additionally achieved by Peltier elements.

The pressing element 4 is moveable relative to the sealing punch 10 in the pressing direction such that the pressing element 4 can be brought into contact with the first packaging-material layer 31 before the sealing punch 10 comes into contact with the first packaging-material layer 31 and/or can remain in contact with the first packaging-material layer 31 when the sealing punch 10 is moved away in a direction away from the anvil plate 11.

In the exemplary embodiment illustrated in FIG. 1, the pressing element 4 is mounted on the sealing punch 10 so as to be moveable in the pressing direction. The pressing element 4 is movable relative to the sealing punch 10 into a first position in which an end of the pressing element 4 having the pressing contour 40 projects in the pressing direction from the sealing punch 10. In embodiments, the pressing element 4 is movable relative to the sealing punch 10 into a second position in which the end of the pressing element 4 having the pressing contour 40 does not project in the pressing direction from the sealing punch 10. In embodiments, the pressing contour 40 in the second position is arranged in a plane with the sealing-seam contour 13.

For moveable mounting of the pressing frame 4 on the sealing punch 10, in the illustrated exemplary embodiment guide rods 5 extending in the pressing direction are provided on the sealing punch 10, on which guide rods the pressing frame 4 is adjustably guided.

The pressing element 4 is acted upon by a force that moves the pressing element 4 into the first position, or toward the first position, relative to the sealing punch 10. In the illustrated exemplary embodiment, the pressing direction is at least substantially vertical, and the pressing element 4 is moved into the first position due to gravity. Supplementarily, in the exemplary embodiment illustrated in FIG. 1, a force device is provided, wherein the pressing element 4 is forced toward the first position by the force device. In embodiments, the pressing element 4 has a small mass in order to keep the actuating forces to be applied for a stroke movement of the sealing punch 10 together with the pressing element 4 mounted thereon small. In embodiments, a force by which the pressing element 4 is moved into the first position is applied at least by half, in particular, by more than 75%, by the force device.

In the illustrated exemplary embodiment, spring elements 50 are provided that force the pressing frame 4 toward the first position. When the sealing punch 10 is lowered in the direction of the anvil plate 11, the pressing frame 4 is forced from the first position in the direction of the second position by contact with the packaging-material layer 31 and by the counterforce applied by the anvil plate, the pressing element 4. In this context, the spring elements 50 are tensioned and cause a pressing force.

In embodiments, instead of, or additionally to, a passive force device comprising spring elements, an active force device is provided comprising, for example, a hydraulic, pneumatic, electromagnetic, or linearly acting electric drive.

In the illustrated exemplary embodiment, the sealing punch 10 comprises a groove 100 in which a flange 42 provided on the pressing element 4 is received. Walls of the groove 100 cooperate with the flange 42 in order to limit a movement of the pressing element 4 relative to the sealing punch 10. In embodiments, a height of the groove 100 in the pressing direction is selected such that, in the sealing position illustrated in FIG. 1, under application of a counterforce by the anvil plate 11, the flange 42 does not contact the groove 100, in order to avoid heating of the pressing element 4 by contact with the sealing punch 10 and in order not to limit the stroke movement of the sealing tool 10.

In embodiments, the pressing element 4 comprises thermal insulation on its surfaces facing the sealing punch 10, for example, in the form of a coating.

For packaging the product 2, the packaging-material layers 31, 32 are joined to one another by the sealing tool 1 along sealing-seam contour 13.

In embodiments, the packaging-material layers 31, 32 are provided as webs. The packaging-material layers 31, 32 are supplied to the sealing tool 1, wherein products 2 are inserted between the webs at regular or irregular intervals. The packaging-material layers 31, 32 are guided through the sealing tool 1.

In embodiments, the packaging-material layers 31, 32 are guided through the sealing tool 1 in a clocked feed, wherein, during feed pauses, a product 2 is arranged in a region inside the sealing-seam contour 13, and the sealing punch 10 and the pressing frame 4 are advanced toward the anvil plate 11 for joining the packaging-material layers 31, 32 along the sealing-seam contour 13.

In embodiments, the packaging-material layers 31, 32 are guided continuously through the sealing tool 1, wherein, for sealing, the sealing tool 1 is adjusted in the direction of movement of the packaging-material layers 31, 32 together therewith.

For producing a seal pouch packaging for the product 2, the sealing punch 10 is advanced toward the anvil plate 11 in the pressing direction.

For sealing, In embodiments, at least one packaging-material layer 31, 32 and/or a coating on a packaging-material layer 31, 32 is melted.

The sealing punch 10 is advanced toward the anvil plate 11 for sealing the packaging-material layers 31, 32 with a sealing pressure and a sealing duration. The sealing pressure, the sealing duration, and/or a temperature to which the sealing punch 10 is heated is, or are, in each case selectable suitably, depending on the application case.

After the end of the sealing process, the sealing punch 10 is moved away from the anvil plate 11 opposite the pressing direction. The pressing element 4 is moved with a time offset relative to the sealing punch 10 and initially remains in contact with the packaging-material layer 31 when raising the sealing punch 10. The pressing element 4 is, in particular, loaded by the force device, for example, the spring elements 50, in order to force the pressing element 4 into a pressing position in which the first packaging-material layer 31 is forced by the pressing element 4 against the second packaging-material layer 32. A time offset is, in this context, selected such that the pressing element 4 is moved out of the pressing position only when a sealing material, in particular, a hot-sealing lacquer, at the sealing seam 33 has solidified.

In embodiments, the pressing frame 4 is cooled, such that solidification of the sealing seam 33 is accelerated and further heat input into the product is avoided.

In embodiments, when advancing the sealing punch 10 toward the anvil plate 11, initially the pressing element 4 projecting in the pressing direction from the sealing punch 10 comes into contact with the packaging-material layer 31.

As can be seen in FIG. 2, in the illustrated exemplary embodiment the sealing-seam contour 13 has, at one end, in particular, at a front end, an outwardly directed V-shaped section. Contours configured in this manner are also referred to as chevron contours, and the sealing seams produced therewith are referred to as chevron seams. Chevron seams permit simple opening of a package closed by the chevron seam. However, the illustrated contour is merely exemplary.

The pressing contour 40 extends along the sealing-seam contour 13. In embodiments, the pressing contour 40 is geometrically similar to the sealing-seam contour 13 and has, at least substantially, the same shape as the sealing-seam contour 13, but is different in size from the sealing-seam contour 13.

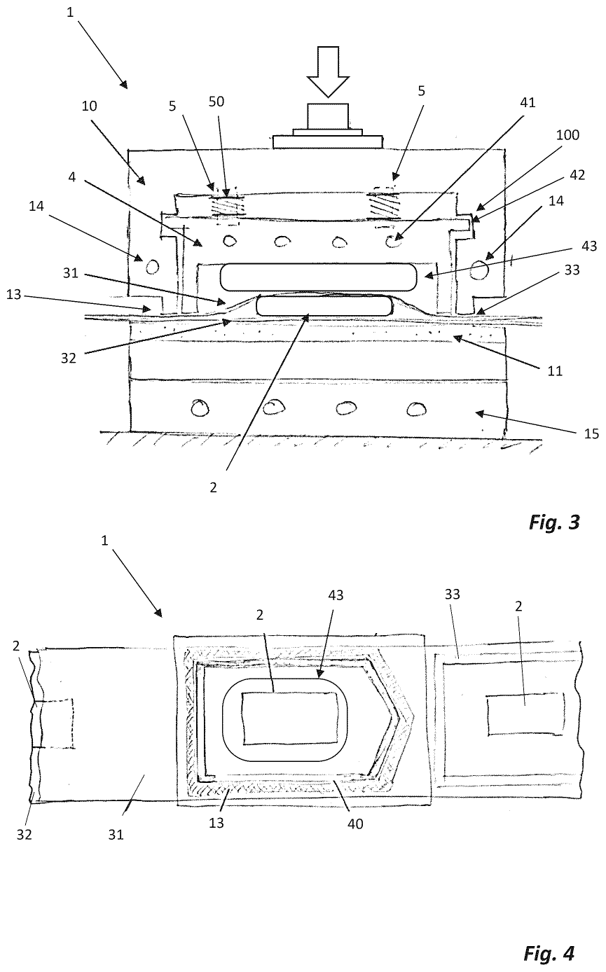

FIGS. 3 and 4 show, in a sectional side view and a partially sectional plan view, an exemplary embodiment of a sealing tool 1 for producing a seal pouch packaging for a product 2 similar to FIG. 1.

In embodiments, a pressure cushion 43 illustrated in FIGS. 3 and 4 is arranged on the pressing element 4, by which a force is applicable to the packaging-material layers 31, 32 and the product 2 arranged therebetween such that gas present between the packaging-material layers 31, 32 and/or in the product 2, in particular, air, is displaced.

In order that the pressing element 4 damages neither the packaging-material layers 31, 32 nor the product 2, the pressing element 4 is, in embodiments, cooled as described above. The pressure cushion is, in particular, received in the pressing element 4 configured as a pressing frame and is cooled therewith in order to avoid damage to the packaging-material layers 31, 32 and/or the product 2 by the pressure cushion.

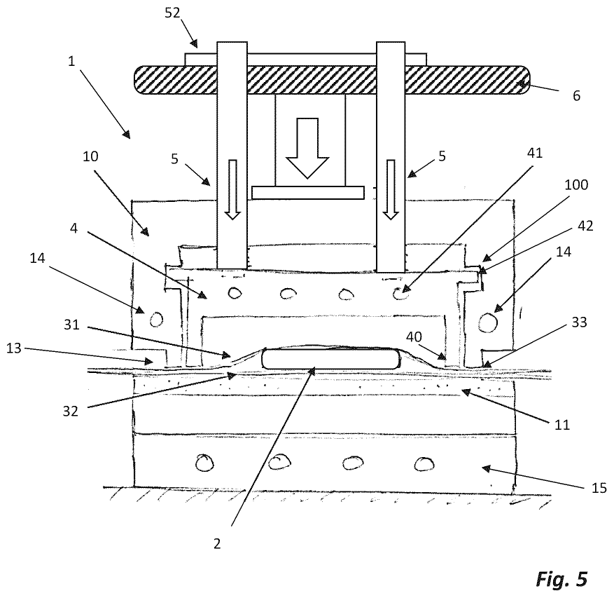

FIG. 5 shows, schematically in a sectional side view, an exemplary embodiment of a sealing tool 1 similar to FIG. 1. In contrast to the configuration according to FIG. 1, in the configuration according to FIG. 5 a carrier 6 is provided, wherein the sealing punch 10 and the pressing element 4 are each mounted on the carrier 6.

The pressing element 4 is mounted, in particular, on the carrier 6 so as to be moveable relative to the sealing punch 10 in the pressing direction such that the pressing element 4, when advancing the sealing punch 10, contacts the element to be sealed before the sealing-seam contour 13 and/or, when moving the sealing punch 10 away from the element to be sealed, lifts off the element to be sealed after the sealing-seam contour 13. For example, the pressing element 4 is mounted on the carrier 6 via guide rods. In embodiments, the pressing element 4 is moveable relative to the carrier 6, as schematically illustrated in FIG. 5, by an actuator drive 52. The actuator drive 52 also serves as an active force device in order to force the pressing element 4 into a first position in which a free end of the pressing element 4 projects from the sealing-seam contour 13.

In embodiments, the sealing punch 10 and the pressing element 4 are each mounted on the carrier 6 so as to be moveable in the pressing direction, as schematically illustrated by arrows in FIG. 5. For example, an actuator drive 18 is provided in order to adjust the sealing punch 10 relative to the carrier 6 in the pressing direction.

The actuator drive 18 for the sealing punch 10 and the actuator drive 52 for the pressing element 4 are, in particular, operable in such a way that the pressing element 4, when advancing the sealing punch 10, contacts the element to be sealed before the sealing-seam contour 13 and/or, when moving the sealing punch 10 away from the element to be sealed, lifts off the element to be sealed after the sealing-seam contour 13.

In embodiments, the sealing punch 10 is mounted fixedly on the carrier 6 and moveable with the carrier 6. The pressing element 4 is thereby mounted on the carrier 6 so as to be moveable and in particular, is forcible, by an active and/or a passive force device, into a first position in which a free end of the pressing element 4 projects from the sealing-seam contour 13.

The illustrated exemplary embodiments are merely exemplary, and numerous modifications are conceivable. In particular, features or elements described in connection with one exemplary embodiment may be combined with another exemplary embodiment in order to obtain further exemplary embodiments.

1. A sealing tool, in particular, for producing a seal pouch packaging for a product,
wherein the sealing tool comprises
a sealing punch,
a pressing element,
a cooling device for cooling the pressing element, and
a pressure cushion,
wherein the sealing punch has a sealing-seam contour at one end, and wherein the sealing punch is advanceable in a pressing direction toward an element to be sealed,
wherein the pressing element, together with the sealing punch, is advanceable toward the element to be sealed and movable away from the element to be sealed,
wherein the pressing element is configured as a pressing frame and has a pressing contour,
wherein the pressing contour extends, at least in sections, along an inside of the sealing-seam contour,
wherein the pressure cushion is arranged in the pressing frame,
wherein the pressing element is mounted so as to be moveable relative to the sealing punch in the pressing direction, and
wherein a force acts on the pressing element such that the pressing element carries out a stroke movement, in such a way that the pressing element, when advancing the sealing punch, contacts the element to be sealed before the sealing-seam contour and/or, when moving the sealing punch away from the element to be sealed, lifts off the element to be sealed after the sealing-seam contour.

2. The sealing tool according to claim 1, wherein the pressing contour extends along the inside of the sealing-seam contour at least substantially parallel thereto.

3. The sealing tool according to claim 1, wherein the cooling device is configured as liquid cooling comprising cooling channels provided on the pressing element and/or the cooling device comprises Peltier elements.

4. The sealing tool according to claim 1, wherein the sealing tool comprises a force device acting on the pressing element.

5. The sealing tool according to claim 4, wherein the force device is a passive force device, which is, in particular, configured as at least one spring element arranged between the sealing tool and the pressing element, in particular, connected to the sealing tool.

6. The sealing tool according to claim 4, wherein the force device is an active force device, which is, in particular, configured as a hydraulic, pneumatic, electromagnetic, or linearly acting electric drive, to effect the stroke movement of the pressing element.

7. The sealing tool according to claim 1, wherein the pressing element is mounted on the sealing punch or on a carrier so as to be moveable in the pressing direction.

8. The sealing tool according to claim 1, wherein the sealing tool comprises a counter element, in particular, an anvil plate and/or a second sealing punch.

9. The sealing tool according to claim 1, wherein the pressure cushion is a flexible and/or compressible insert that interacts with the seal pouch packaging in order to remove a present gas, in particular, air, from the product and/or between packaging-material layers.

10. A packaging machine for producing a seal pouch packaging for a product to be packaged therein, wherein the seal pouch packaging comprises a first packaging-material layer and a second packaging-material layer, wherein the packaging machine is configured to introduce the product between the two packaging-material layers, wherein the packaging machine comprises a sealing tool according to claim 1 in order to seal the packaging-material layers to one another along a sealing seam.

11. The method according to the invention for producing seal pouch packaging comprising a first packaging-material layer and a second packaging-material layer for a product to be packaged, wherein the product is introduced between the two packaging-material layers, and the packaging-material layers are sealed to one another along a sealing seam,
wherein a sealing punch is advanced toward the packaging-material layers in a pressing direction, such that a sealing-seam contour of the sealing punch bears against the first packaging-material layer facing the sealing punch,
wherein a pressing element, together with the sealing punch, is advanced toward the packaging-material layers and bears against the first packaging-material layer facing the sealing punch,
wherein the pressing element is moved at least partially with a time offset relative to the sealing punch, such that, when advancing the sealing punch, the pressing element bears against the first packaging-material layer before the sealing-seam contour, and/or,
when moving the sealing punch away from the packaging-material layers, the pressing element lifts off from the first packaging-material layer after the sealing-seam contour,
wherein the pressing element is cooled in order to avoid heating of the packaging-material layers by the pressing element, and
wherein the product, during and/or before sealing the packaging-material layers along the sealing seam, is compressed by a pressure cushion arranged inside the sealing-seam contour.

12. The method according to claim 11, wherein the pressing element, when lifting off the sealing-seam contour, is forced against the first packaging-material layer for a pressing duration and/or until reaching a maximum adjustment travel between the sealing punch and the pressing element, in particular, by a force device.

13. The method according to claim 11, wherein, when advancing the sealing punch, the pressure cushion begins compressing the product before the sealing-seam contour contacts the first packaging-material layer.
